(19) United States
(12) Patent Application Publication
(10) Pub. No.: US 2025/0020171 A1
(43) Pub. Date: Jan. 16, 2025

(54) PENDULUM ROCKER DAMPER HAVING A ROTATION AXIS

(71) Applicant: Schaeffler Technologies AG & Co. KG, Herzogenaurach (DE)

(72) Inventors: Jean-Francois Heller, Strassburg (FR); Frank Rübel, Karlsruhe (DE); Yannick Strub, Roeschwoog (FR); Ludovic Voorspoels, Drusenheim (FR)

(73) Assignee: Schaeffler Technologies AG & Co. KG, Herzogenaurach (DE)

(21) Appl. No.: 18/711,613

(22) PCT Filed: Nov. 7, 2022
(86) PCT No.: PCT/DE2022/100819

§ 371 Date: May 20, 2024

(30) Foreign Application Priority Data
Dec. 9, 2021 (DE) 10 2021 132 417.3

(51) Int. Cl. F16D 3/12; F16D 3/14

(52) U.S. Cl. CPC F16D 3/12; F16D 3/14; F16D 2300/22

(57) ABSTRACT

A pendulum rocker damper for a drive train of a motor vehicle includes a rotation axis (D), and a rocker unit for modulating a torque. The rocker unit includes a primary flange connectable to a first external connection, a rocker element preloaded by an energy storage element, a first roller and a second roller, and a secondary flange connectable to a second external connection. The first roller can roll on a first rocker-side roller track and a primary flange-side roller track complementary to the first rocker-side roller track. The second roller can roll on a second rocker-side roller track and a secondary flange-side roller track complementary to the second rocker-side roller track. A friction device is arranged between the primary flange and the secondary flange. The friction device has a first component non-rotatable with the primary flange and a second component non-rotatable with the secondary flange.

### CROSS-REFERENCE TO RELATED APPLICATIONS

This application is the United States National Phase of PCT Appln. No. PCT/DE2022/100819 filed Nov. 7, 2022, which claims priority to German Application No. DE102021132417.3 filed Dec. 9, 2021, the entire disclosures of which are incorporated by reference herein.

### TECHNICAL FIELD

The present disclosure relates to a pendulum rocker damper having a rotation axis for a drive train, having a rocker unit for modulating a torque.

### BACKGROUND

So-called pendulum rocker dampers are already known from the prior art. For example, pendulum rocker dampers for modulating the stiffness of a rotating shaft or a rotating shaft system in a drive train are known from DE 10 2019 121 204 A1 and DE 10 2019 121 205 A1. These pendulum rocker dampers comprise a primary flange and a secondary flange, which are connected to one another (in both directions) in a torque-transmitting manner. Interposed are a plurality of rocker elements (also referred to as rockers) and a plurality of spring elements. The rocker elements are supported by means of at least one rolling element on the primary flange and/or the secondary flange such that they can be displaced relative to one another. The rolling elements are clamped by means of the spring elements so that they can roll between the respective transmission track and the complementary counter track. This pendulum rocker damper converts the relative rotation angle between the primary flange and the secondary flange into a spring deflection of the spring elements.

By means of the transmission tracks and the complementary counter tracks, which form a ramp gear, a transmission ratio can be adjusted and thus the stiffness of the pendulum rocker damper can be adjusted. Here, it is also advantageous that the transmission ratio need not be constant, but rather the gradient of the ramp gear can be variably adjusted via the rotation angle of the primary flange to the secondary flange.

The known pendulum rocker dampers require a large amount of installation space and are designed to reduce the stiffness of the rotating shaft. If so-called excess torques occur during operation, i.e., torques that exceed the operating limit of one of the spring elements, only protective measures of the pendulum rocker damper against such peak loads are known from the prior art that require significant installation space.

### SUMMARY

The present disclosure provides a friction device in the pendulum rocker damper with little impact on the installation space.

According to the disclosure, a pendulum rocker damper has a rotation axis for a drive train of a motor vehicle and a rocker unit for modulating a torque. The rocker unit includes:
a primary flange which can be connected in a torque-transmitting manner to a first external connection;
at least one rocker element preloaded by an energy storage element;
at least one first and one second roller; and
a secondary flange which can be connected in a torque-transmitting manner to a second external connection.

The first roller is mounted such that it can roll on a first rocker-side roller track and a primary flange-side roller track complementary to the first rocker-side roller track, the second roller is mounted such that it can roll on a second rocker-side roller track and a secondary flange-side roller track complementary to the second rocker-side roller track, and a friction device is arranged between the primary flange and the secondary flange.

Since a first component of the friction device is designed to be non-rotatable with the primary flange and a second component of the friction device is designed to be non-rotatable with the secondary flange, the friction device can be accommodated in the pendulum rocker damper with little impact on the installation space. The friction device or the two components of the friction device create a frictional torque that counteracts an incoming torque and thus acts as a damper. The energy required for the relative rotation of the secondary flange with respect to the primary flange therefore dissipates to some extent in the friction device in the form of thermal energy, resulting in a hysteresis dependent on the rotation angle. For example, the pendulum rocker damper proposed here can be used to modulate torque in a small installation space and at the same time provide protection against excess torque.

Unless explicitly stated otherwise, reference is made to the stated rotation axis when the terms “center”, “axial direction”, “radial direction”, or “direction of rotation” as well as corresponding terms are used in the following. Unless explicitly stated otherwise, ordinal numbers used in the preceding and subsequent description are used only for the purposes of clear distinction and do not indicate an order or a ranking of designated components. An ordinal number greater than one does not necessarily mean that a further such component must be present.

The friction device may be variable, i.e., the frictional torque depends on the relative rotation of the secondary flange with respect to the primary flange.

The rocker unit for modulating a torque includes the at least one rocker element. The rocker element is mounted by means of at least one or more (e.g., two or three) rollers on the primary flange and/or on the secondary flange so that it can be pivoted, i.e., rocked, relative to the direction of rotation (or superimposed on the rotation movement). Two energy storage elements and two rocker elements may be provided.

If two or more rocker elements are provided, the at least one energy storage element may be provided between two rocker elements, and a rocking movement of the two rocker elements results in a relative movement of the two rocker elements in relation to one another. The relative movement in turn results in a change in the energy potential of the at least one energy storage element. If two rocker elements are provided, e.g., one or two energy storage elements are provided, which may be arranged at opposite ends of the rocker elements in each case. If three rocker elements are provided, e.g., three energy storage elements are provided. If only one rocker element is provided, the energy storage element may be arranged between the rocker element and either the secondary flange or the primary flange, so that the energy potential of the energy storage element changes during a relative movement between the rocker element and the secondary flange or the primary flange resulting from the rocking movement.

The primary flange of the rocker unit is connected or can be connected in a torque-transmitting manner to the first external connection and the secondary flange of the rocker unit is connected or can be connected in a torque-transmitting manner to the second external connection. The primary flange, the secondary flange and/or the at least one rocker element is or may be formed in the manner of a disc or disc segment, e.g., by means of stamping and/or sheet metal forming.

The at least one roller is arranged on the rocker-side roller track and the primary flange-side roller track complementary thereto in such a way that it is in a rest position within the roller tracks without the application of a torque or also when a low torque is applied. When a (larger) torque is applied, the at least one roller rolls (at least almost) slip-free on the corresponding roller tracks. The at least one roller may be preloaded against the roller tracks by means of the at least one energy storage element. A ramp gear is thus formed by the at least one roller and the corresponding roller track. The roller tracks have a gradient which is selected in such a way that additional (kinetic) energy or work is required in order to overcome the gradients. The required (kinetic) energy can be achieved by reducing a torsional oscillation or the torque to be modulated. For example, a stiffness or damping value can be represented or adjusted by means of the gradient of the roller tracks and/or the stiffness of the energy storage element. This allows for a modulated torque transmission from the primary flange to the secondary flange or vice versa. The at least one energy storage element is, for example, a helical compression spring, for example with a straight spring axis, a bow spring or a gas pressure accumulator. The energy storage element can be expanded or compressed by a movement of the primary flange and the secondary flange relative to one another.

In an example embodiment, two energy storage elements are arranged transversely to the axis of rotation in such a way that both energy storage elements are compressed when torque is applied, so that the torque can be modulated by means of the stiffness of the energy storage elements in conjunction with the ramp gradient of the path pair(s).

For example, if a rotational movement is initiated by an external connection, such as the primary flange, the relative movement between the primary flange and the secondary flange causes the roller on the rocker-side roller track and the complementary outer-side roller track to roll (up) from the rest position in the corresponding direction on the ramp-like roller track. The term “rolling up” is used here merely to illustrate that work is being performed. More precisely, an opposing force of the at least one energy storage element is overcome due to the geometric relationship. The term “rolling down” therefore refers to releasing stored (kinetic) energy from the at least one energy storage element. The terms “up” and “down” therefore do not necessarily correspond to a spatial direction.

It should be noted that a rotational movement initiated via the secondary flange and the corresponding second external connection can also be torque-modulated in the manner described above. The rocker unit proposed here is compact because the arrangement of the roller tracks on the respective rocker element allows for a compact design.

In an example embodiment, two sets of rollers are provided between the primary flange and the secondary flange, on two corresponding pairs of roller tracks in each case with two roller tracks each. In this case, a first pair of roller tracks is arranged with a first rocker-side roller track on the at least one rocker element and a primary flange-side roller track on the primary flange in order to receive at least one primary-side roller or a set of primary-side rollers such that it/they can roll. In this embodiment, a second pair of roller tracks includes a second rocker-side roller track on the rocker element and a secondary flange-side roller track on the secondary flange and is designed to receive at least one secondary-side roller or a set of secondary-side rollers such that it/they can roll. The first pair of roller tracks may be arranged radially outside of the second pair of roller tracks.

The first component may be formed integrally with the primary flange and/or the second component may be formed integrally with the secondary flange. This allows for a compact design of the pendulum rocker damper.

Furthermore, the first component may be formed as a section projecting inwards in the radial direction of the pendulum rocker damper on the primary flange or may be connected to the primary flange. This allows for a compact design of the pendulum rocker damper.

Furthermore, the second component may be formed as a section projecting outwards in the radial direction of the pendulum rocker damper on the secondary flange or may be connected to the secondary flange. This allows for a compact design of the pendulum rocker damper.

The primary flange and the secondary flange may overlap in the axial direction of the pendulum rocker damper. They may be arranged in the same axial plane. This allows for a compact design of the pendulum rocker damper.

The first component may be designed as a spring device preloaded in the axial direction of the pendulum rocker damper against the secondary flange and/or the second component may be designed as a spring device preloaded in the axial direction of the pendulum rocker damper against the primary flange.

The spring device may have two spring plates fastened to the secondary flange. One of the spring plates may be arranged on one side of the secondary flange and the other of the spring plates may be arranged in the axial direction on the other side of the secondary flange. Both spring plates may clamp the primary flange between them in a friction-locking manner.

The spring plates may be fastened to the section projecting outwards in the radial direction on the secondary flange and may be in friction-locking contact with a circular arc section of the primary flange, which is limited in the circumferential direction of the pendulum rocker damper by two stops projecting inwards in the radial direction. The secondary flange-side section can come into contact with one of the stops in each case in order to limit the rotation of the pendulum rocker damper. This allows for a compact design of the pendulum rocker damper.

The spring device may have two spring plates fastened to the primary flange. One of the spring plates may be arranged on one side of the primary flange and the other of the spring plates may be arranged in the axial direction on the other side of the primary flange. Both spring plates may clamp the secondary flange between them in a friction-locking manner.

The spring plates may be designed in the form of circular arc segments and may be in friction-locking contact with the outwardly projecting section of the secondary flange. The primary flange may have two stops projecting inwards in the radial direction and spaced apart from one another in the circumferential direction of the pendulum rocker damper, and the secondary flange-side section can come into contact with one of the stops in each case in order to limit the rotation of the pendulum rocker damper. This allows for a compact design of the pendulum rocker damper.

### BRIEF DESCRIPTION OF THE DRAWINGS

The above disclosure is explained in detail below against the relevant technical background with reference to the accompanying drawings, which show exemplary embodiments. The disclosure is in no way restricted by the purely schematic drawings, wherein it should be noted that the drawings are not dimensionally accurate and are not suitable for defining proportions. Features that are not identified as essential to the disclosure in the following description of the drawings are to be understood as optional. In the figures:

FIG. 1 shows a top view of a first exemplary embodiment of a pendulum rocker damper with a friction device;

FIG. 2 shows a sectional view of the pendulum rocker damper from FIG. 1;

FIG. 3 shows a top view of the pendulum rocker damper from FIG. 1, wherein the rocker elements at the top, i.e., the right-hand rocker elements with reference to FIG. 2, have been removed, in overrun mode (FIG. 3a), in the neutral state (FIG. 3b) and in traction mode (FIG. 3c);

FIG. 4 shows a perspective view of the friction device of the pendulum rocker damper from FIG. 1 fastened to a secondary flange without the primary flange;

FIG. 5 shows a perspective view of the friction device of the pendulum rocker damper from FIG. 1 fastened to the secondary flange with the primary flange;

FIG. 6 shows a top view of the details of the primary and secondary flange of the pendulum rocker damper from FIG. 1;

FIG. 7 shows a top view of a second exemplary embodiment of a pendulum rocker damper with a friction device (FIG. 7a), wherein the rocker elements at the top with reference to FIG. 7a have been removed (FIG. 7b), and wherein the rocker elements at the top with reference to FIG. 7a and parts of the friction device have been removed;

FIG. 8 shows a perspective view of the friction device of the pendulum rocker damper from FIG. 7a fastened to a primary flange without the secondary flange;

FIG. 9 shows a perspective view of the friction device of the pendulum rocker damper from FIG. 7a fastened to the primary flange with the secondary flange; and

FIG. 10 shows a perspective view with a different sectional plane of the friction device of the pendulum rocker damper from FIG. 7a fastened to the primary flange with the secondary flange.

### DETAILED DESCRIPTION

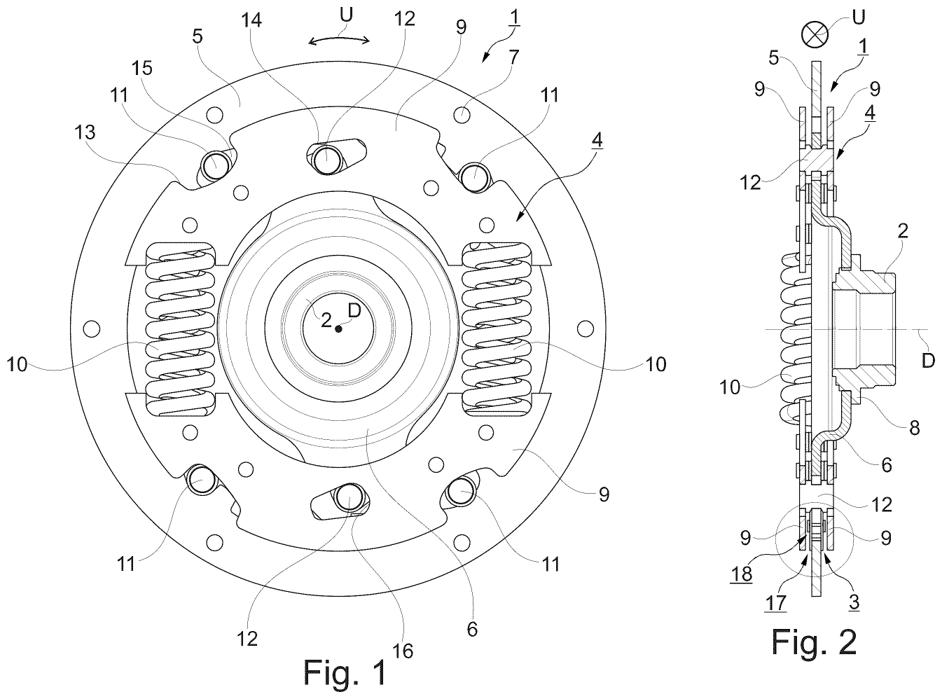

FIGS. 1 to 6 relate to a first exemplary embodiment of a pendulum rocker damper 1. With reference to FIG. 1, the basic structure and basic mode of operation of the pendulum rocker damper 1 are described below, which are equally relevant for the second exemplary embodiment.

The pendulum rocker damper 1 has a rocker unit 4 for modulating a torque, which is arranged so as to rotate about a rotation axis D of the pendulum rocker damper 1. The rocker unit 4 has a primary flange 5, which can be connected in a torque-transmitting manner to a first external connection 7, and a secondary flange 6, which can be connected in a torque-transmitting manner to a second external connection 8. The secondary flange 6 is arranged inside the primary flange 5 in the radial direction R of the pendulum rocker damper 1.

The pendulum rocker damper 1 may be provided in a drive train of a motor vehicle. For example, the primary flange 5 of the rocker unit 4 can be connected to friction linings of a clutch disc, the output side of a slip clutch or the output side of a flywheel. For example, the secondary flange 6 of the rocker unit 4 can be connected to a hub 2 or include the hub 2, by means of which the pendulum rocker damper 1 can be mounted and connected to an intermediate shaft or an input shaft of a transmission, for example.

The rocker unit 4 also has at least one rocker element 9 preloaded by an energy storage element 10. A plurality of rocker elements 9 (in this case two rocker elements each spaced apart in the axial direction A of the pendulum rocker damper 1 and connected in a non-rotatable manner to one another by means of spacer bolts) is provided in the torque flow direction between the, for example, annular primary flange 5 and the secondary flange 6. In the shown exemplary embodiment, the primary flange 5 and the secondary flange 6 are arranged in the axial direction A between two rocker elements 9 spaced apart in the axial direction A.

The primary flange 5 and the secondary flange 6 overlap in the axial direction A of the pendulum rocker damper 1. For example, the primary flange 5 and the secondary flange 6 are arranged in the same axial plane, at least in the region of the rocker elements 9. This means that at least one of the flanges 5, 6 is arranged completely within the axial extension of the other flange 6, 5.

Between the upper rocker element 9, as shown in the figure, and the lower rocker element 9, as shown in the figure, two energy storage elements 10 are arranged here corresponding to the number of rocker elements 9, which may be designed as helical compression springs with a straight spring axis. The energy storage elements 10 hold the two rocker elements 9 in a rest position in the position shown. The energy storage elements 10 shown here are (optionally) identical.

The two rocker elements 9 are each solely connected to the primary flange 5 in a torque-transmitting manner by means of (here purely optionally four) primary-side rollers 11 via a first rocker-side roller track 13 and a primary flange-side roller track 15. The primary flange 5 forms the primary flange-side roller track 15 and is thus coupled to the rocker elements 9 via a cam gear formed in this way by means of the first rocker-side roller track 13. The primary-side rollers 11 are (optionally) preloaded here by means of the energy storage elements 10 against the respective corresponding primary flange-side roller track 15 of the primary flange 5 and the first rocker-side roller track 13 of the rocker elements 9 and can thus only be moved in a rolling manner.

The rocker elements 9 are, in turn, coupled (forming a second rocker-side roller track 14) via a further cam gear formed there with a (here purely optionally single) secondary-side roller 12 via a secondary flange-side roller track 16 to the secondary flange 6 and via this to the hub 2 in a torque-transmitting manner. The secondary flange 6 is connected to the hub 2 in a torque-transmitting manner purely optionally by means of a predamper (not shown).

Thus, the rocker unit 4 has at least a first and a second roller 11, 12. The first roller 11 is mounted such that it can roll on the first rocker-side roller track 13 and the primary flange-side roller track 15 complementary to the first rocker-side roller track 13. The second roller 12 is mounted such that it can roll on the second rocker-side roller track 14 and the secondary flange-side roller track 16 complementary to the second rocker-side roller track 14.

When a torque gradient is applied (from the primary flange 5 to the secondary flange 6), the primary flange 5 is rotated in the circumferential direction U of the pendulum rocker damper 1 relative to the secondary flange 6 and, as a result, the rocker elements 9 are moved towards one another in this embodiment by the rollers 11, 12 rolling on the corresponding (ramp-like) roller tracks 13, 15, 14, 16 on the primary flange 5 and the rocker elements 9 or on the secondary flange 6 and the rocker elements 9. In the process, the energy storage elements 10 are compressed because a relative rotation angle between the primary flange 5 and the secondary flange 6 is translated into a corresponding spring deflection of the energy storage elements 10.

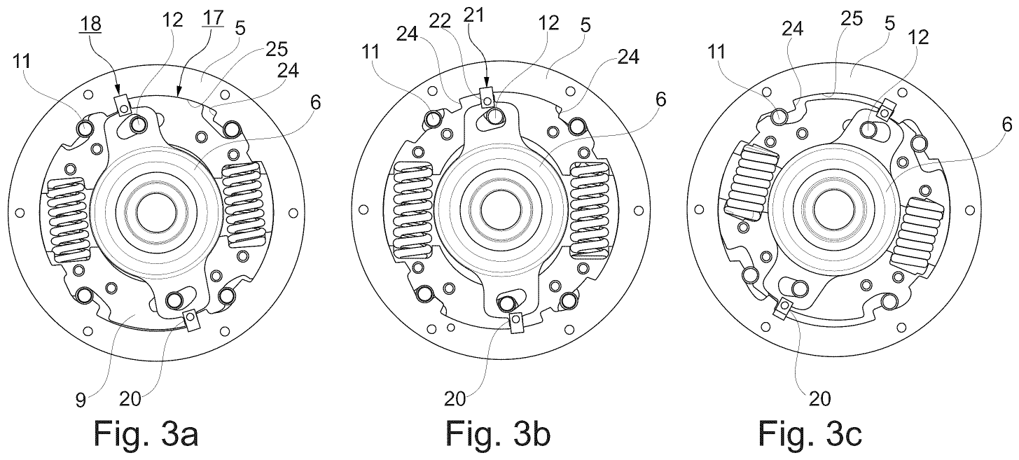

In this context, reference is also made to FIGS. 3a to 3c with regard to the first exemplary embodiment, in which the rocker elements 9 located at the top in the drawing plane have been removed, wherein FIG. 3a shows the pendulum rocker damper 1 in overrun mode, FIG. 3b shows the pendulum rocker damper 1 in the neutral state, and FIG. 3c shows the pendulum rocker damper 1 in traction mode.

The geometry of the roller tracks 13, 15, 14, 16 (cam gear) can be used to adjust the ratio between the rotation angle and the spring deflection. The torque can be modulated via the stiffness (or rather softness) of the energy storage elements 10, i.e., a torque gradient can be defined as a function of an input torque.

FIG. 2 shows the pendulum rocker damper 1 from FIG. 1 in a sectional view, wherein a friction device 3, which is arranged between the primary flange 5 and the secondary flange 6 and which is concealed in FIG. 1 by the rocker elements 9 located at the top in the drawing plane, can be seen.

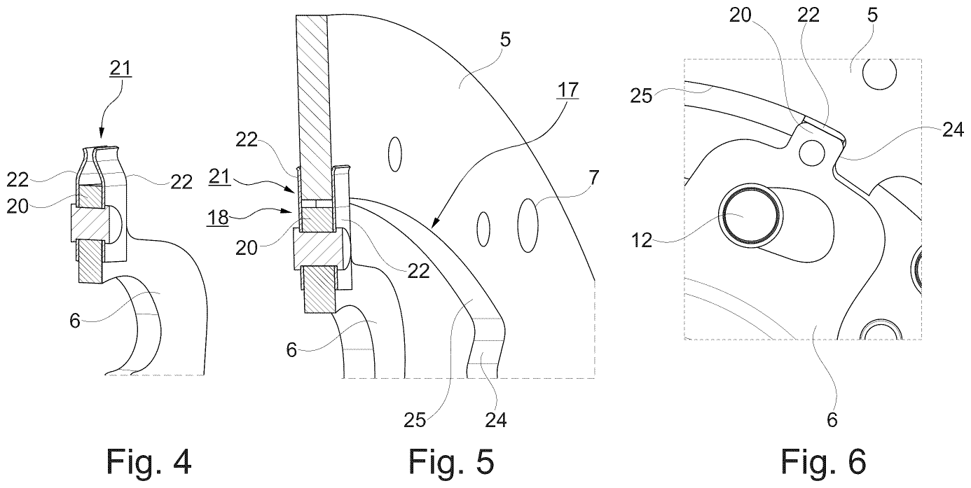

As can be seen in particular from FIGS. 2, 4 and 5, a spring device 21 preloaded in the axial direction A against the primary flange 5 is formed on the secondary flange 6. More precisely, the spring device 21 consists of two spring plates 22 fastened to the secondary flange 6. One of the spring plates 22 is arranged on one side of the secondary flange 6. The other of the spring plates 22 is arranged in the axial direction A on the other side of the secondary flange 6. Both spring plates 22 are preloaded against one another in the axial direction A in a tweezer-like manner, as can be seen in particular from FIG. 4, wherein both spring plates 22 clamp the primary flange 5 between them in a friction-locking manner, as can be seen in particular from FIG. 5. The spring device 21 or the two spring plates 22 are non-rotatable with respect to the secondary flange 6.

The two spring plates 22 are fastened to a section 20 projecting outwards in the radial direction R on the secondary flange 6 and are in friction-locking contact with a circular arc section 25 of the primary flange 5, which is limited in the circumferential direction U by two stops 24 of the primary flange 5 projecting inwards in the radial direction R. Depending on whether the pendulum rocker damper 1 is in traction mode (FIGS. 3c and 6) or overrun mode (FIG. 3a), the secondary flange-side section 20 projecting outwards in the radial direction R can come into contact with one of the stops 24 in each case in order to limit the rotation of the pendulum rocker damper 1.

A first component 17 of the friction device 3, in the present exemplary embodiment the circular arc section 25 of the primary flange 5, is designed to be non-rotatable with the primary flange 5. More precisely, the first component 17 is formed integrally with the primary flange 5. A second component 18 of the friction device 3, in the present exemplary embodiment the section 20 projecting outwards in the radial direction R, to which the spring device 21 or the two spring plates 22 is/are fastened, is formed integrally with the secondary flange 6. Alternatively or in addition, the second component 18 can be designed as a spring device 21 preloaded in the axial direction A of the pendulum rocker damper 1 against the primary flange 5.

The spring device 21 may be provided in the vicinity of the secondary flange-side roller track 16 on the secondary flange 6. In particular, the number of spring devices 21 corresponds to the number of secondary flange-side roller tracks 16, in the shown exemplary embodiment two, i.e., two pairs of spring plates 22.

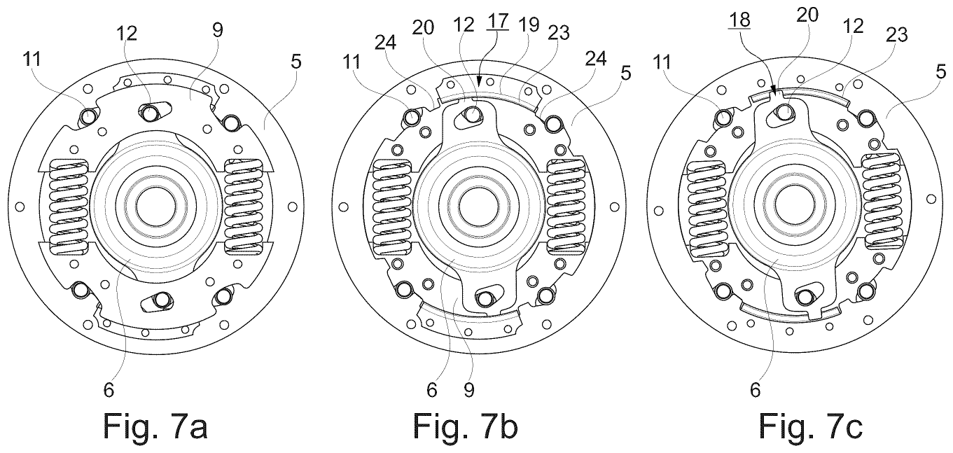

FIGS. 7a to 10 relate to a second exemplary embodiment of the pendulum rocker damper 1 with the friction device 3. FIG. 7a shows a top view of the pendulum rocker damper 1. In FIG. 7b, the rocker elements 9 at the top with reference to FIG. 7a have been removed. In FIG. 7c, the rocker elements 9 at the top with reference to FIG. 7a and parts of the friction device 3 have been removed.

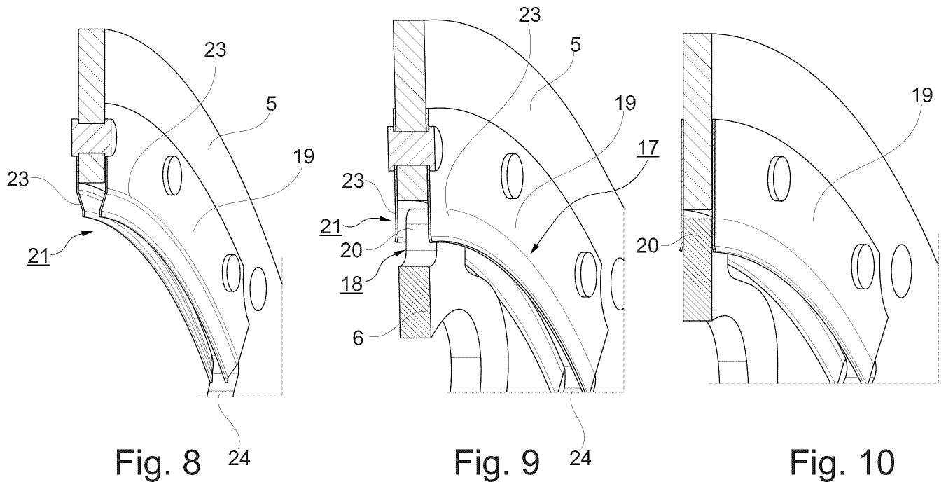

The spring device 21 has two spring plates 23 fastened to the primary flange 5. One of the spring plates 23 is arranged on one side of the primary flange 5. The other of the spring plates 23 is arranged in the axial direction A on the other side of the primary flange 5. Both spring plates 23 are preloaded against one another in the axial direction A in a tweezer-like manner, as can be seen in particular from FIG. 8, wherein both spring plates 23 clamp the secondary flange 6 between them in a friction-locking manner, as can be seen in particular from FIGS. 9 and 10. The spring device 21 or the two spring plates 23 are non-rotatable with respect to the primary flange 5.

The two spring plates 23 are designed in the form of circular arc segments and are in friction-locking contact with the outwardly projecting section 20 of the secondary flange 6. The primary flange 5 has the two stops 24 projecting inwards in the radial direction R and spaced apart from one another in the circumferential direction U of the pendulum rocker damper 1. Depending on whether the pendulum rocker damper 1 is in traction mode or overrun mode, the secondary flange-side section 20 projecting outwards in the radial direction R can come into contact with one of the stops 24 in each case in order to limit the rotation of the pendulum rocker damper 1.

The second component 18 of the friction device 3, in the present exemplary embodiment the section 20 of the secondary flange 6 projecting outwards in the radial direction R, is designed to be non-rotatable with the secondary flange 6. More precisely, the second component 18 is formed integrally with the secondary flange 6.

The first component 17 is connected in a non-rotatable manner to the primary flange 5 in the form of a section 19 projecting inwards in the radial direction R of the pendulum rocker damper 1, in the present exemplary embodiment as a spring device 21 or as two spring plates 23 preloaded in the axial direction A against the secondary flange 6. Alternatively, the first component can be formed on the primary flange 5 or be integral with the primary flange.

The preceding exemplary embodiments relate to a pendulum rocker damper 1 having a rotation axis D for a drive train of a motor vehicle, having a rocker unit 4 for modulating a torque. The rocker unit has a primary flange 5 which can be connected in a torque-transmitting manner to a first external connection 7; at least one rocker element 9 preloaded by an energy storage element 10; at least one first and one second roller 11, 12; and a secondary flange 6 which can be connected in a torque-transmitting manner to a second external connection 8. The first roller 11 is mounted such that it can roll on a first rocker-side roller track 13 and a primary flange-side roller track 15 complementary to the first rocker-side roller track 13, and the second roller 12 is mounted such that it can roll on a second rocker-side roller track 14 and a secondary flange-side roller track 16 complementary to the second rocker-side roller track 14. A friction device 3 is arranged between the primary flange 5 and the secondary flange 6. A first component 17 of the friction device 3 is designed to be non-rotatable with the primary flange 5 and a second component 18 of the friction device 3 is designed to be non-rotatable with the secondary flange 6.

The friction device 3 or the two components 17, 18 of the friction device 3 create a frictional torque that counteracts an incoming torque and thus acts as a damper. The energy required for the relative rotation of the secondary flange 6 with respect to the primary flange 5 therefore dissipates to some extent in the friction device 3 in the form of thermal energy, resulting in a hysteresis dependent on the rotation angle. The friction device may be variable, i.e., the frictional torque depends on the relative rotation of the secondary flange 6 with respect to the primary flange 5. The pendulum rocker damper 1 proposed here can be used to modulate torque in a small installation space and at the same time provide protection against excess torque.

### REFERENCE NUMERALS

1 Pendulum rocker damper
2 Hub
3 Friction device
4 Rocker unit
5 Primary flange
6 Secondary flange
7 Primary-side external connection
8 Secondary-side external connection
9 Rocker element
10 Energy storage element
11 Primary-side roller
12 Secondary-side roller
13 First rocker-side roller track
14 Second rocker-side roller track
15 Primary flange-side roller track
16 Secondary flange-side roller track
17 First component
18 Second component
19 Inwardly projecting section
20 Outwardly projecting section
21 Spring device
22 Spring plate
23 Spring plate
24 Stop
25 Circular arc section
A Axial direction
D Rotation axis
R Radial direction
U Circumferential direction

1. A pendulum rocker damper for a drive train of a motor vehicle, having a rotation axis (D), and a rocker unit for modulating a torque, the rocker unit comprising:
a primary flange which can be connected in a torque-transmitting manner to a first external connection;
a rocker element preloaded by an energy storage element;
a first roller and a second roller; and
a secondary flange which can be connected in a torque-transmitting manner to a second external connection,
wherein the first roller is mounted such that it can roll on a first rocker-side roller track and a primary flange-side roller track complementary to the first rocker-side roller track,
wherein the second roller is mounted such that it can roll on a second rocker-side roller track and a secondary flange-side roller track complementary to the second rocker-side roller track, and
wherein a friction device is arranged between the primary flange and the secondary flange, a first component of the friction device is designed to be non-rotatable with the primary flange, and a second component of the friction device is designed to be non-rotatable with the secondary flange.

2. The pendulum rocker damper according to claim 1, wherein the first component is formed integrally with the primary flange or wherein the second component is formed integrally with the secondary flange.

3. The pendulum rocker damper according to claim 1, wherein the first component is formed as a section projecting inwards in the radial direction (R) of the pendulum rocker damper on the primary flange or is connected to the primary flange.

4. The pendulum rocker damper according to claim 1, wherein the second component is formed as a section projecting outwards in the radial direction (R) of the pendulum rocker damper on the secondary flange or is connected to the secondary flange.

5. The pendulum rocker damper according to claim 1, wherein the primary flange and the secondary flange overlap in the axial direction (A) of the pendulum rocker damper and are preferably arranged in the same axial plane.

6. The pendulum rocker damper according to claim 1, wherein the first component is designed as a spring device preloaded in the axial direction (A) of the pendulum rocker damper against the secondary flange or wherein the second component is designed as a spring device preloaded in the axial direction (A) of the pendulum rocker damper against the primary flange.

7. The pendulum rocker damper according to claim 6, wherein the spring device has two spring plates fastened to the secondary flange, wherein one of the spring plates is arranged on one side of the secondary flange and the other of the spring plates is arranged in the axial direction (A) on the other side of the secondary flange, and wherein both spring plates clamp the primary flange between them in a friction-locking manner.

8. The pendulum rocker damper according to claim 7, wherein the spring plates are fastened to a section projecting outwards in the radial direction (R) on the secondary flange and are in friction-locking contact with a circular arc section of the primary flange, which is limited in the circumferential direction (U) of the pendulum rocker damper by two stops projecting inwards in the radial direction (R), wherein the secondary flange-side section can come into contact with one of the stops in each case in order to limit the rotation of the pendulum rocker damper.

9. The pendulum rocker damper according to claim 6, wherein the spring device has two spring plates fastened to the primary flange, wherein one of the spring plates is arranged on one side of the primary flange and the other of the spring plates is arranged in the axial direction (A) on the other side of the primary flange, and wherein both spring plates clamp the secondary flange between them in a friction-locking manner.

10. The pendulum rocker damper according to claim 9, wherein the spring plates are designed in the form of circular arc segments and are in friction-locking contact with an outwardly projecting section of the secondary flange, wherein the primary flange has two stops projecting inwards in the radial direction (R) and spaced apart from one another in the circumferential direction (U) of the pendulum rocker damper, and wherein the secondary flange-side section can come into contact with one of the stops in each case in order to limit the rotation of the pendulum rocker damper.
